(19) United States
(12) Patent Application Publication
(10) Pub. No.: US 2015/0324741 A1
(43) Pub. Date: Nov. 12, 2015

(54) System for Tracking Shipments

(71) Applicant: Pathology Associates Medical Laboratories, LLC, Spokane, WA (US)

(72) Inventors: John Mathew Parry, Spokane, WA (US); Tamra Dee Pock, Spokane Valley, WA (US); JoAnn Fay Farnsworth, Spokane, WA (US); Michael Lee Fowler, Spokane Valley, WA (US); Aaron Borg, Spokane, WA (US)

(73) Assignee: Pathology Associates Medical Laboratories, LLC, Spokane, WA (US)

(21) Appl. No.: 14/272,196

(22) Filed: May 7, 2014

(51) Int. Cl. G06Q 10/08

(52) U.S. Cl. CPC G06Q 10/0833; G06Q 10/08355

(57) ABSTRACT

This disclosure describes, in part, systems and techniques for tracking shipments from multiple locations in transit with multiple couriers. In some implementations, this disclosure describes a tracking service which uses data sources to generate one or more tracking interfaces which may allow a user to dynamically monitor and/or modify each shipment. In some implementations, each tracking interface may include tracking data from the data sources such as shipment origin, courier information, tracking identification numbers for each shipment from the multiple locations, items in the shipment, and/or identification numbers for the items in the shipment.

### BACKGROUND

Businesses are continuously seeking ways to operate more efficiently. In some instances, where a business must coordinate receiving shipments from different locations, the business may seek to more efficiently track the incoming shipments from the different locations in order to allow for timely processing of the shipments. This may be particularly important where the shipments contain time-sensitive, environment-sensitive, and/or fragile material.

One problem with tracking the incoming shipments from the different locations is that many different modes of transportation may be used to ship the shipments. Each of the different transportation modes may have a separate method for tracking a shipment which may be cumbersome and time consuming for the business to separately track the shipments from each of the different couriers. Another problem occurs when one of the different transportation modes is delayed and the business is unable to quickly determine shipping alternatives and/or when the shipment is actually scheduled to arrive. As such, there remains a need for a shipment tracking system that integrates the separate tracking methods of the different transportation modes to allow a business to track shipments for different locations and dynamically inform the business of delays in each shipment.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic diagram of an illustrative environment for a tracking service to provide a tracking interface to a user.

FIG. 2 is a block diagram of an illustrative computing architecture to provide a tracking interface to a user by a tracking service.

FIG. 3 illustrates an example tracking interface to provide tracking information on pending or in-route shipments.

FIG. 4 illustrates additional functionality of the example tracking interface shown in FIG. 3 having a pop-up window with shipment tracking information.

FIG. 5 illustrates an example notification of a delayed shipment generated by the tracking service.

FIG. 6 illustrates an example tracking interface to provide tracking information on previously received and/or canceled shipments.

FIG. 7 illustrates an example tracking interface to allow a user to configure shipment details for shipments.

FIG. 8 illustrates an example interface to allow a user to alter route details for a shipment.

FIG. 9 illustrates an example tracking interface to provide tracking service administrative tools to a user.

### DETAILED DESCRIPTION

This disclosure describes, in part, systems and techniques for tracking shipments from multiple locations in transit with multiple couriers. In some implementations, this disclosure describes a tracking service which uses data sources to generate one or more tracking interfaces which may allow a user to dynamically monitor and/or modify each shipment. In some implementations, each tracking interface may include tracking data from the data sources such as shipment origin (e.g., geographic location and/or shipping entity), courier or vendor information (e.g., courier name, courier address, courier telephone number, airline, air carrier, and/or flight number etc), transportation mode (e.g., ground, air, rail, drone, etc), shipping speed (e.g., overnight, 2-day, etc), special handling instructions, tracking identification numbers for each shipment from the multiple locations, items in the shipment, and/or identification numbers for the items in the shipment.

As mentioned above, each tracking interface may include information regarding the transportation mode of one or more shipment. In some implementations, the transportation mode may include information regarding ground shipments. That is, shipment by any land-based method of transportation. For example, shipment by trucks, cars, trains, etc. In some implementations, the transportation mode may include information regarding air shipments. That is, shipment by any air-based method of transportation. For example, shipment by an airplane, a drone aircraft, etc. In the implementations of drone aircraft, the tracking system may have additional functionality such as live video feeds from the drone aircraft, and/or real-time adjustment of the drone aircraft route, etc.

To illustrate an example use of the tracking system, envision a user such as a business that processes a large quantity of time-sensitive healthcare shipments (e.g., blood samples, tissue samples, bodily fluids, organs, etc) from hundreds of labs, clinics, hospitals, and/or individuals located in multiple states across the country. In many instances, the healthcare shipments may require processing and/or testing within a particular time period and/or shipment within a particular temperature range. In order to be able to timely and efficiently process and/or test the large quantity of healthcare shipments, the user may need to have a detailed knowledge of when each healthcare shipment is to arrive, from what location the healthcare shipment was shipped, and/or what items are present in the healthcare shipment. The user may use this information to prioritize processing or testing of the healthcare shipments and/or coordinate staff to receive the healthcare shipments.

In some implementations, the tracking data supplied to the tracking service and/or acquired from the data sources is data that is external to the tracking service. For instance, the data sources may be a third party monitoring service (e.g., FedEx Priority Alert™), a weather monitoring service, a traffic monitoring service, a global positioning system (GPS) monitoring system, a flight tracking network (e.g., Flightaware®), etc. In some implementations, the tracking data supplied to the tracking service is data that is internal to the tracking service. For instance, the tracking data may be data input by other users associated with the tracking service.

In some implementations, the tracking service may generate a notification when the tracking data indicates that a shipment is delayed or canceled. In these implementations, the notification may be sent via email, text message, web interface, instant message, telephone call (human or automated), social network and/or other notification modes to one or more users of the tracking service to help the one or more users to identify such delayed or canceled shipments.

The tracking service may provide a shipment history as part of the tracking interface to allow a user to accurately determine details about received shipments. For instance, the shipment history may include details about an actual time the shipment was received, who delivered the shipment, what was included in the shipment, and/or how the shipment was handled by one or more couriers during shipment. In some implementations, the tracking system may review the shipment history to determine shipment trends by a courier and/or predict delays from a shipment origin. For instance, the tracking system may review the shipment history recognize that a particular shipping vendor and/or mode of transportation has a pattern of delay from a particular location. In some instance, the tracking system may suggest an alternative shipping vendor and/or mode of transportation to avoid shipment delay.

Furthermore, the tracking service may allow a user to configure shipment routes. For instance, the tracking service may allow a user to add new routes for shipment of items, delete existing routes for shipment of items, or alter existing routes for shipment of items. In some implementations, altering an existing route may include changing a courier, adding one or more stops on the route for pick-up of additional items, and/or deleting one or more stops on the route to omit pick-up of additional items for shipment. In some implementations, the tracking service may suggest an update to an existing route. For instance, the tracking service may determine based on the data from the weather monitoring service and/or traffic monitoring service that a shipment may be delayed because of weather and/or traffic along the shipment route. In those implementations, the tracking service may suggest an expedited shipment and/or an alternate route, for example.

The techniques for tracking shipments from multiple locations by multiple courier and generating a tracking interface as described herein may be implemented in a variety of ways and by a variety of electronic devices.

### Illustrative Environment

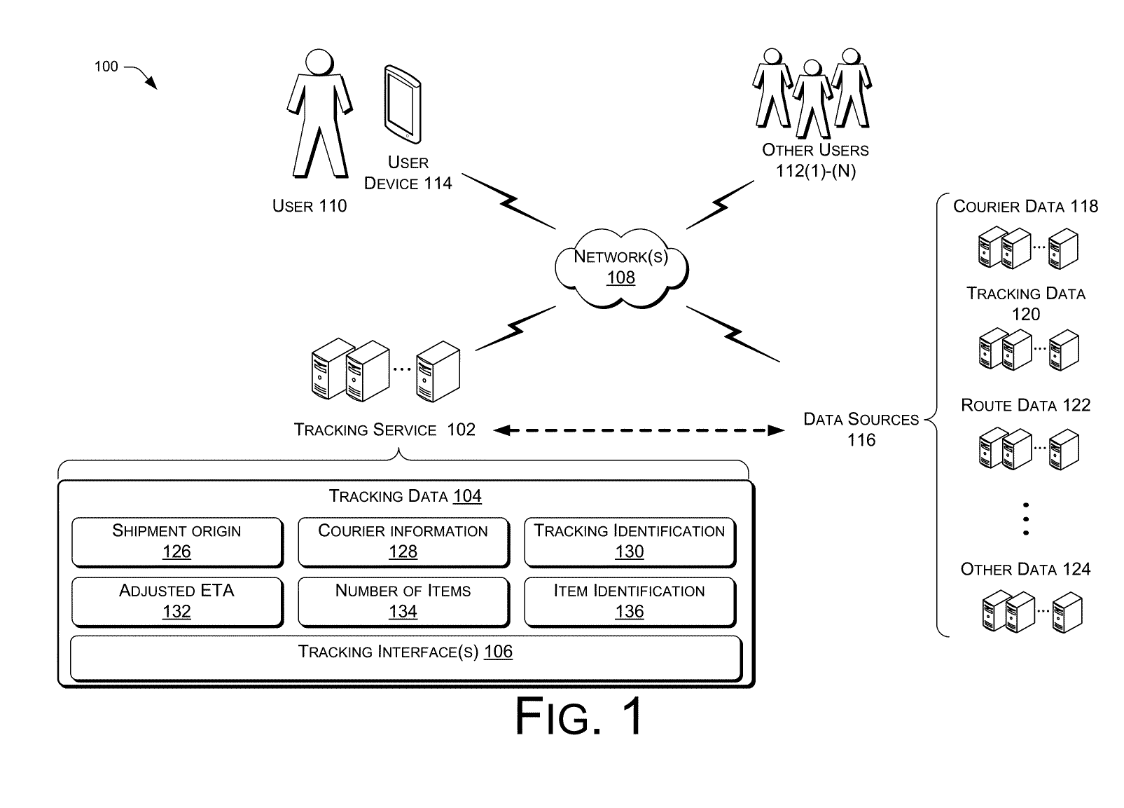

FIG. 1 is schematic diagram of an illustrative environment 100 for providing one or more tracking interfaces on an electronic device by a tracking service. As illustrated, environment 100 may include a tracking service 102 which uses tracking data 104 to generate one or more tracking interfaces 106. The tracking service 102 may be hosted by one or more computing devices or servers and may communicate with other computing devices or servers via one or more networks 108. The networks 108 may include wireless and/or wired networks, including mobile telephone networks, wide area networks (WANs), and so forth.

The tracking service 102 may communicate with one or more users, which may include user 110 and the other users 112(1)-(N). User 110 may use a device 114 to communicate with the tracking service 102 and/or interact with the tracking interface(s) 106 provided by the tracking service 102. The device 114 may include virtually any type of electronic device or computing device that can exchange information with another device. For example, the devices 114 may be any one or more of mobile telephones, smart telephones, notebook computers, tablets, desktop computers, vehicle computing devices, kiosks, and/or other types of electronic devices. The tracking service 102 may provide the tracking interface 106 to the device 114 (or any other device) through a browser, a dedicated application or “app”, and/or through messaging services such as short message service (SMS), email, and other messaging services.

As mentioned above, the tracking service 102 may utilize data provided by the user 110 and/or data provided by the other user 112(1)-(N) to generate the tracking interface 106. In some instances, the user 110 and the other users 112(1)-(N) may be employees of a particular business using the tracking service 102. In some implementations, the tracking service 102 may utilize data from one or more data sources 116. As illustrated, the tracking service 102 may communicate with the data sources 116 via networks 108 to access various types of information to include in the tracking interface(s) 106. For instance, the tracking service 102 may communicate with courier data 118, tracking data 120, route data 122, and/or other data 124 to obtain one or more tracking data 104 for inclusion in the tracking interface(s) 106. In some implementations, the one or more data sources 116 may include data provided by a third party. In some implementations, the one or more data sources 116 may be accessible via public or private data repositories available to the tracking service 102. For instance, tracking service 102 may store, or at least have access to, the data associated with the data sources 116.

The courier data 118 may include information that is stored by, or that is supplemental to, the tracking service 102 about the particular courier(s) or delivery service(s) handling items of each of the multiple shipments to user 110. In some implementations, the courier data 118 may include a particular courier that is handling each of the multiple shipments at a particular moment in time, contact information of the courier (s) (e.g., telephone numbers, email addresses, etc), and/or type of courier (e.g., air, ground, etc).

The tracking data 120 may include information that is stored by, or that is supplemental to, the tracking service 102 about a specific location of each of the multiple shipments or multiple couriers. In some implementations, tracking data 120 may utilize tracking information such as tracking numbers, tracking barcodes, air waybill numbers, global positioning information, and so forth as information to more accurately determine the actual or real-time position of a particular shipment at any point during transit. In some implementations, the tracking data 120 may allow the tracking service 102 to provide an adjusted or dynamic estimated-time-of-arrival (ETA) in the tracking interface(s) 106 to user 110 as the shipment is in transit.

The route data 122 may include information that is stored by, or that is supplemental to, the tracking service 102 about specific details regarding a shipping route of each of the multiple shipments. For instance, the route data 122 may include specific and/or additional location(s) of stops along a shipping route. In some implementations, the route data 122 may include details about transportation mode and/or courier transitions along a particular route. For instance, a particular route may begin with a ground courier but may transition to an air courier or another ground courier at a particular point in transit. In some implementations, the route data 122 may include information, accessible by the tracking service 102 and/or via input by the other users 112(1)-(N), corresponding to weather along the shipment route and/or traffic along the shipment route.

The other data 124 may include information that is stored by, or that is supplemental to, the tracking service 102 about other shipment details. For instance, the other data 124 may include information about the number of boxes or items in a particular shipment, an identification number associated with the boxes or items, care precautions for the boxes or items in the particular shipment (e.g., fragile, hazardous material, temperature requirements, etc). In some implementations, the other data 124 may be accessible by the tracking service 102 and/or via input by the other users 112(1)-(N).

As described above, FIG. 1 illustrates that the tracking interface 106 generated for the user 110 may include tracking data 104 from the data sources 116 such as shipment origin 126, courier information 128, tracking identification 130, an adjusted ETA 132, a number of items in the shipment 134, and an identification of the items in the shipment 136.

### Illustrative Computing Architecture

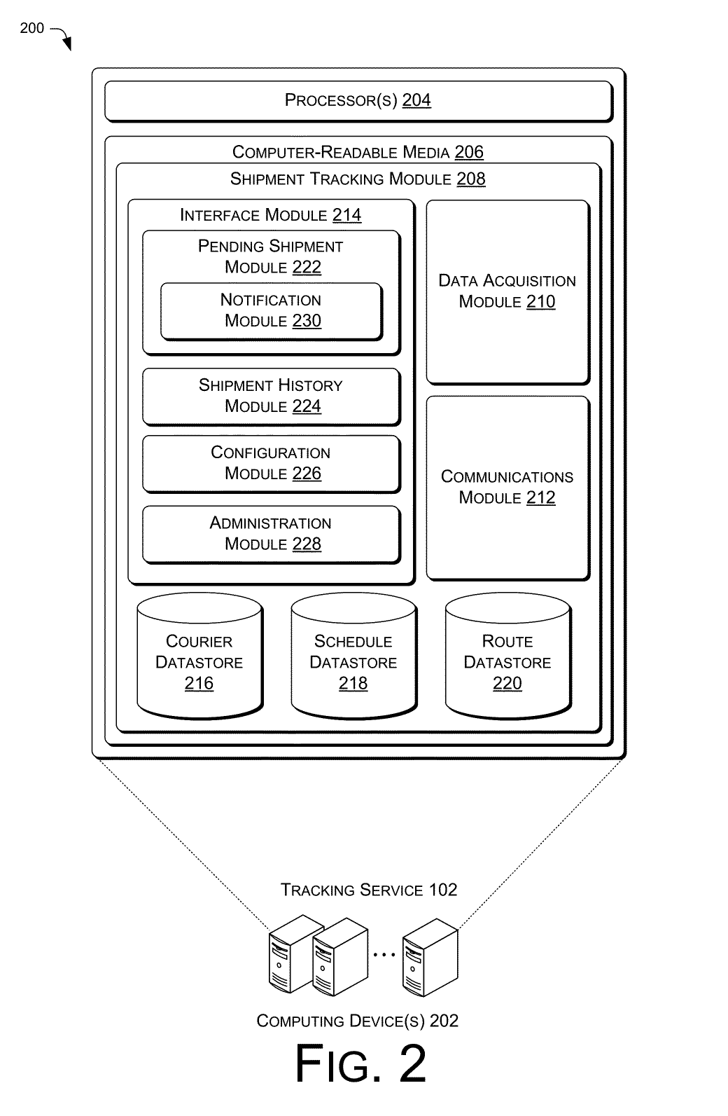

FIG. 2 shows a block diagram of an illustrative computing architecture 200 for the tracking service 102 to provide one or more tracking interfaces. The computing architecture 200 may include one or more computing devices 202 that may be implemented in a distributed or non-distributed computing environment.

The computing devices 202 may include one or more processors 204 and one or more computer-readable media 206 that stores various modules, applications, programs, or other data. The computer-readable media 206 may include instructions that, when executed by the one or more processors 204, cause the processors to perform the operations described herein for the tracking service 102.

Implementations may be provided as a computer program product including a non-transitory machine-readable storage medium having stored thereon instructions (in compressed or uncompressed form) that may be used to program a computer (or other electronic device) to perform processes or methods described herein. The machine-readable storage medium may include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions. Further, embodiments may also be provided as a computer program product including a transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks. For example, distribution of software may be by an Internet download.

In some implementations, the computer-readable media 206 may store a shipment tracking module 208. The shipment tracking module 208 may include various modules, such as a data acquisition module 210, a communications module 212, and an interface module 214, each of which are described in detail below. The modules may be stored together or in a distributed arrangement. In some implementations, the modules may represent services that may be performed using components that are provided in a distributed arrangement, such as by virtual machines running in a cloud computing environment. In some implementations, one or more data stores may be included in the computing architecture 200, accessible by the computing device 202 and the shipment tracking module 208. The one or more data stores may include a courier data store 216, a schedule data store 218, and a route data store 220.

As mentioned above, the shipment tracking module 208 may include a data acquisition module 210. In some implementations, the data acquisition module 210 may access and/or acquire data from the one or more data sources 116. For instance, the data acquisition module 210 may acquire data from tracking data 120 in order to accurately determine the actual or real-time position of a particular shipment at any point in time. In some implementations, the data acquisition module 210 may store and provide a username and/or password of a user 110 or the tracking service 102 to a private web portal of one or more of the data sources 116 in order for the data acquisition module 210 to acquire the tracking data. In some implementations, the one or more data sources 116 may offer an application program interface (API) to allow the data acquisition module 210 to call each of the one or more data sources 116 via the network(s) 108 for the tracking data without direct user interaction. In yet other implementations, the data acquisition module 210 may pull data from one or more of the data sources 116 that provide publically available data.

The shipment tracking module 208 may include a communications module 212. In some implementations, the communications module 212 may allow user 110 of the shipment tracking module 208 to communicate with the one or more data sources 116 and/or the other users 112(1)-(N) of the tracking service 102. In some implementations, the communication from the communications module 212 may be communications to a vendor, courier and/or individual route stop(s) to alter an overall shipment route and/or shipment schedule as a shipment travels toward a destination. In some implementations, the communication from the communications module 212 may be communications to create a new shipment or delete an existing shipment. In some implementations, the communication from the communications module 212 may be communications to add a new courier and/or new shipment detail from a new shipment origin.

In some implementations, the shipment tracking module 208 may utilize the data acquired by the data acquisition module 210 to create one or more tracking interface(s). In some implementations, the shipment tracking module 208 may include an interface module 214 which may organize and present the data acquired by the data acquisition module 210 to a user. For instance, interface module 214 may present one or more tracking interface(s) on a display of user device 114 for consumption by user 110. The interface module 214 may include a pending shipment module 222, a shipment history module 224, a configuration module 226, and an administration module 228.

In some implementations, the interface module 214 may allow for simultaneous presentation of shipment tracking information to one or more users on one or more devices. In some implementations, the interface module 214 may simultaneously present the shipment tracking information to one or more users in multiple different time zones while automatically updating the shipment tracking information based on the time zone of each user. As described in detail below, the various modules of the interface module 214 may allow a user to view, select, alter, and/or configure shipment information for one or more shipments from multiple origin locations. In some implementations, interface module 214 may be provided in the computer readable media 206 and may be executed on the processers 204 to provide a user interface to assist the user 110 in operation of tracking service 102. The interface module 214 may allow tactile entry of requests (e.g., via touchscreen or touchpad, etc.), textual entry of requests (e.g., via a cursor, controller, keyboard, etc.), audible entry of requests (e.g., via a microphone), or entry of requests in any other manner.

The pending shipment module 222 may generate and organize information for all shipments that the user may anticipate a destination receiving within a pre-determined period of time for presentation in a tracking interface. For instance, the pending shipment module 222 may generate and organize information such as shipment status (e.g., on-time, delayed, canceled, picked-up, received, etc); name of the shipment origin (e.g., city, region, hospital, clinic, lab, etc); courier (e.g., name, type, etc); flight number where the courier is an airline; shipment tracking identification (e.g., tracking number, air waybill, etc); a real-time ETA for the shipment; a number of items in the shipment; and/or an identification of the items in the shipment. In some implementations, the pending shipment module 222 may allow for organization, such as sorting and/or filtering, of the tracking interface based on any of the information generated by the pending shipment module 222.

In some implementations, information generated and presented by pending shipment module 222 in the tracking interface may include a hyperlink to additional content that may be internal to the shipment tracking module 208 or external to the shipment tracking module 208. For instance, a user 110 may click or hover over the location of information, such as a shipment tracking identification number, presented on the tracking interface. In some implementations, additional content regarding the shipment tracking identification number may be presented to user 110. For instance, the additional information may open an external website of a courier with information about the tracking identification of a shipment or retrieve courier contact information from the courier data store 216. In other implementations, the additional information presented in the tracking interface may be a map identifying the real-time position of the shipment.

The pending shipment module 222 may include a notification module 230. In some implementations, the notification module 230 may receive information from the pending shipment module 222 that a particular shipment has been delayed or canceled. In some implementations, the notification module 230 may create and/or present a notification or announcement to a user that a particular shipment has been updated (e.g., delayed or canceled). In some implementations, the notification module 230 may include details in the generated notification corresponding to the updated shipment. For instance, the notification module 230 may generate an interface to be sent via email, short message service (SMS) or multimedia message service (MMS) to the user device 114 of the user 110 that a particular shipment has been delayed. The generated notification, as will be shown below, may include a web link to a tracking interface showing updated tracking information regarding the particular shipment, a shipment origination location, a current courier, a current tracking number provided by the courier, one or more future courier, one or more previous courier, an original ETA of the shipment, an updated ETA of the shipment, a reason for delay/cancelation, a number of items in the shipment, tracking identification of the items in the shipment, and/or a timestamp of the most recent tracking update.

As mentioned above, the interface module 214 may include a shipment history module 224 which may generate and organize information for received and/or canceled shipments. For instance, the shipment history module 224 may generate and organize information such as shipment status (e.g., canceled and/or received), name of the shipment origin (e.g., city, region, hospital, clinic, lab, etc), courier (s) (e.g., name, type, etc); flight number where the courier is an airline, shipment tracking identification (e.g., tracking number, air waybill, etc), an actual time the shipment was received or canceled, number of items in the shipment, and/or identification of the items in the shipment. In some implementations, the shipment history module 224 may allow for organization, such as sorting and/or filtering, of the tracking interface based on any of the information generated by the shipment history module 224.

In some implementations, the interface module 214 may include a configuration module 226 which may generate and organize information corresponding to shipment schedules, routes, couriers, airports, user preferences, and/or user locations. In some implementations, the configuration module 226 may present an interface which works in conjunction with the communications module 212 to allow a user to add, delete, or alter details about a particular shipment. As mentioned above, the communication module 212 may communicate with one or more vendors and/or couriers to implement the altered details for the particular shipment. In some implementations, the vendors and/or couriers may have access to the one or more tracking interfaces in order to receive the altered details for the particular shipment. For instance, the configuration module 226 may generate an interface for presentation to user 110 on device 114 which allows user 110 to add and/or delete stops on a particular shipment route. In some implementations, the configuration module 226 may allow for organization, such as sorting and/or filtering, of the tracking interface based on any of the information generated by the configuration module 224.

As mentioned above, the interface module 214 may include an administration module 228 which may generate and organize information corresponding to an audit log displaying all shipment tracking module 208 actions. In some implementations, the administration module 228 may allow a system administrator of the shipment tracking module 208 to add users, alter existing users, and/or delete users. In some implementations, the administration module 228 may allow for organization, such as sorting and/or filtering, of the tracking interface based on any of the information generated by the administration module 228. For instance, the information generated by the administration module 228 may be sorted by a time of the shipment tracking module 208 actions and/or a user who completed the action.

It should be noted that the modules described herein are just examples and that in other examples different modules may be used to perform the noted function(s). In some implementations, certain modules may be combined with other modules to perform the noted function(s). In some implementations, the module function(s) may be split/distributed and/or rearranged.

### Illustrative Tracking Interfaces

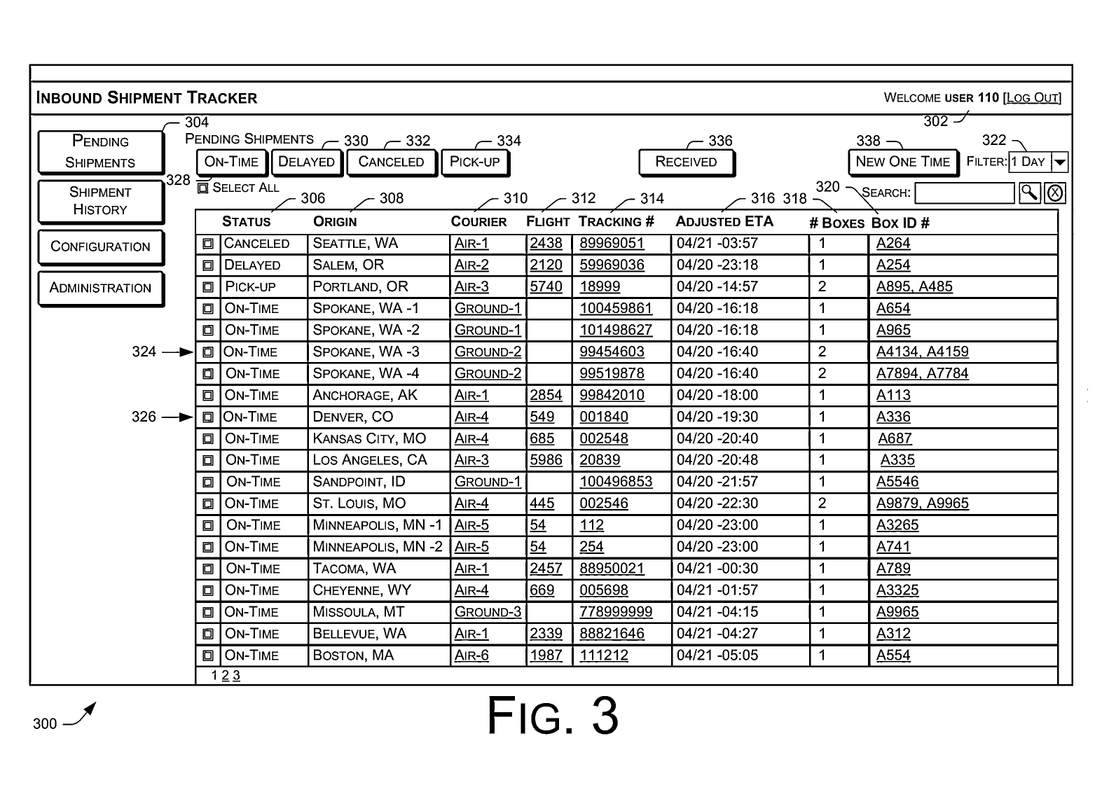

FIGS. 3-9 illustrate various example tracking interfaces generated by the interface module 214 of the shipment tracking module 208 for presentation on an electronic device, such as device 114 of the user 110. More specifically, the example tracking interfaces may be generated by the pending shipment module 222, shipment history module 224, configuration module 226 and/or the administration module 228 as described above.

FIG. 3 illustrates an example tracking interface 300 generated by the pending shipment module 222 of the interface module 214 for presentation on an electronic device. The example interface 300 may include a location 302 of a user currently logged into the tracking service 102. For instance, FIG. 3 shows at location 302 that user 110 is logged onto the tracking service 102.

Tracking interface 300 illustrates that user 110 may select the pending shipment box 304. In some implementations, upon selection of the pending shipment box 304, the interface module 214 may provide an indication of selection by, for example, highlighting box 304.

In some implementations, one or more columns and rows of tracking information may appear within interface 300 after receiving the selection of the pending shipment box 304. As shown in FIG. 3, each row of information may be highlighted in a manner that is different from the adjacent rows. In some implementations, the information in the one or more columns and rows may be acquired by the data acquisition module 210 and may include a shipment status 306, a shipment origin name 308, a current shipment courier 310, a flight number 312 where the current courier is an air carrier, a shipment tracking number 314, an adjusted shipment ETA 316, a number of items 318 (e.g., boxes) in the shipment, and/or identification of the item 320 in the shipment. In some implementations, the interface 300 may be sorted by any of the information presented in the one or more columns (i.e., a shipment status 306, a shipment origin name 308, a current shipment courier 310, etc). Furthermore, the interface 300 may be filtered to display pending shipments for a select number of day(s) by selecting the filtering tab 322.

As shown in FIG. 3, row 324 of interface 300 illustrates that a pending shipment has a status of “on-time”, the shipment originated from “Spokane, WA-3” via a courier “Ground-2” with a shipment tracking number “99454603” with an adjusted ETA of “04/20-16:40.” Furthermore, row 324 illustrates that a pending shipment includes “2 boxes” where a first box has an identification number of “A4134” and a second box has an identification number of “A4159.”

While row 326 of interface 300 illustrates that a pending shipment originating from “Denver, Colo.” is “on-time.” The pending shipment highlighted in row 326 is being handled by “Air-4” on flight “549” with an air waybill of “001840” and an adjusted ETA of “04/20 19:30.” Finally, row 326 shows that the pending shipment includes “1 box” and the identification number of the box is “A336.”

In some implementations, the adjusted shipment ETA 316 may present a time that a shipment is expected to arrive at a location designated by a user of the tracking service 102. In some implementations, the adjusted shipment ETA may be updated based on data acquired by the data acquisition module 210 from the one or more data sources 116. For instance, the adjusted shipment ETA may be adjusted in real-time based on the tracking data 120 corresponding to a specific location of each of the multiple shipments presented in the interface 300. In another instance, the adjusted shipment ETA may be adjusted in real-time based on the route data 122 corresponding to weather and/or traffic delays along the shipment route.

In some implementations, the identification of the shipment item 320 in the shipment may allow the user of the tracking service to specifically identify the contents of the items in the shipment. For instance, the identification of the shipment item 320 in the shipment may include a tracking number of each box in a particular shipment. In this implementation, the tracking number of each individual box in a particular shipment may be accessed by the data acquisition module 210 for inclusion in interface 300.

In some implementations, one or more icons or indicia representing one or more tools may appear within interface 300 after receiving the selection of the pending shipment box 304. For instance, the one or more tools may include an on-time box 328, a delayed box 330, a canceled box 332, a pick-up box 334, a received box 336, and/or a new one time box 338. In some implementations, when an indication is received that a selection of the canceled box 332 and/or the received box 336, the corresponding row of tracking information for a selected pending shipment may be removed from the interface 300. In some implementations, a user may further select the one or more tools to alter a sort of the displayed or selected columns and rows of tracking information, provide additional tracking data to the tracking service 102, and/or create a new pending shipment.

For instance, the shipment status 306 may be re-sorted after receiving a selection of one of the one or more tools (i.e., on-time box 328, delayed box 330, canceled box 332, pick-up box 334 and/or received box 336) to display pending shipment information corresponding to the selected tool.

In some implementations, the selection of one of the one or more tools, such as the received box 336, may allow a user to override the tracking service 102 by providing additional tracking data that one or more pending shipments have been received.

In some implementations, the selection of one or more tools, such as the new one time box 338, may allow the user of the tracking service 102 to request a new shipment. In some implementations, such a selection may prompt the communications module 212 to initiate communication with one or more vendor and/or couriers, one or more shipment origination locations, one or more data sources 116 and/or the other users 112(1)-(N) to gather tracking information and create a new pending shipment for display in interface 300.

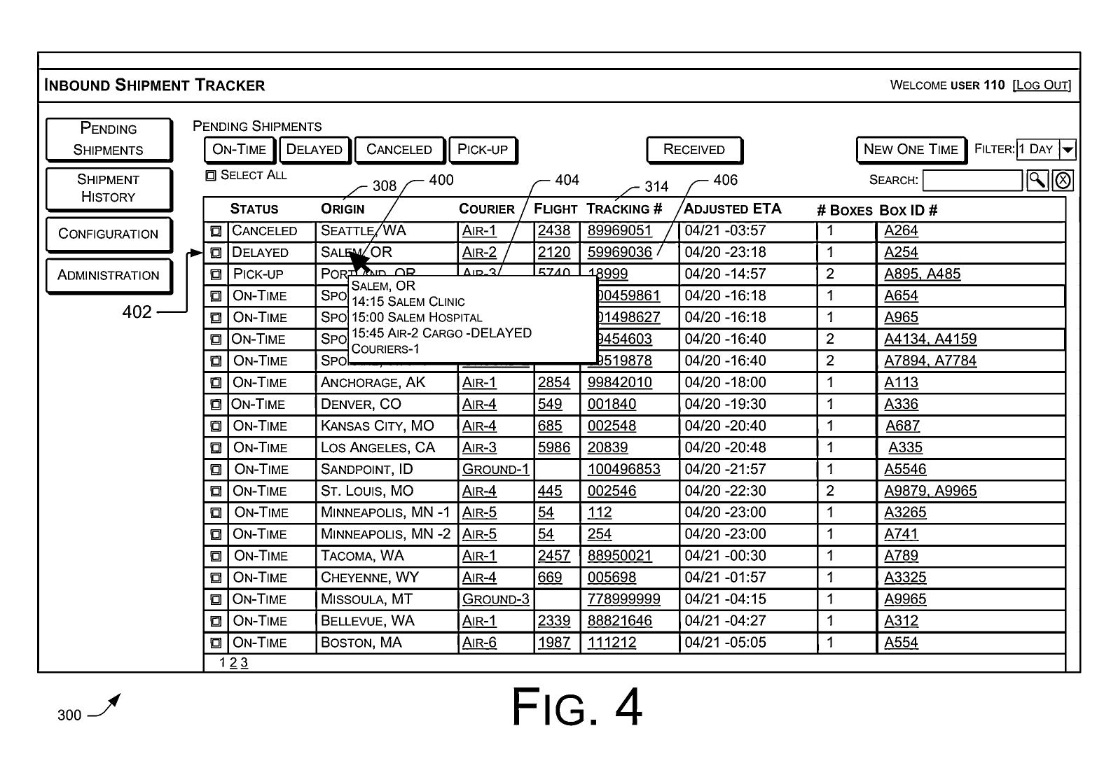

FIG. 4 illustrates additional details of the tracking interface 300. In some implementations, when a user, such a user 110, manipulates a cursor, highlights, or touches an area containing tracking information, the pending shipment module 222 may generate additional details for display regarding the pending shipment. For instance, when user 110 manipulates cursor 400 over the shipment origin name 308 “Salem, OR” of row 402, the pending shipment module 222 may generate and present the pop-up box 404 on tracking interface 300. In some implementations, the pop-up box 404 may include additional details corresponding to the pending shipment. For instance, pop-up box 404 includes specific details of a time and location of one or more route stops of the pending shipment as the shipment moves through transit toward its destination. Here, the pending shipment from Salem, Oregon had a first stop at 14:15 at Salem Clinic, followed by a second stop at 15:00 at the Salem Hospital; however, at the third stop the pop-up box 404 illustrates that the shipment was received at Air-2 Cargo at 15:45 but is delayed at that location. In some implementations, the pop-up box 404 may also show times/locations of future route stops and/or names of future courier of the pending shipment.

FIG. 4 also illustrates that the tracking information provided in each column or row of the tracking interface 300 may include a hyperlink to access additional content regarding the tracking information. In some implementations, upon receiving a request to access the additional content (i.e., click, touch, and so forth) from a user, the communications module 212 may initiate communication with one or more data sources 116 to allow the data acquisition module 210 to acquire data related to the additional content.

For instance, a user 110 may click on the shipment tracking identification 314 presented in row 402 of the tracking interface 300 and, as a result, additional content regarding the shipment tracking identification may be presented to the user 110. In some implementations, the additional information may be contained on an external website of a courier with information about the shipment tracking identification and/or exact location of the pending shipment. For instance, the additional information for a flight number 312 presented in row 402 of the tracking interface 300 may include a pop-up window displaying a flight duration, an average departure time (e.g., 7-day average, monthly average, yearly average, average since route inception, etc.), an average arrival time (e.g., 7-day average, monthly average, yearly average, average since route inception, etc.), a flight route, a flight distance, and so forth.

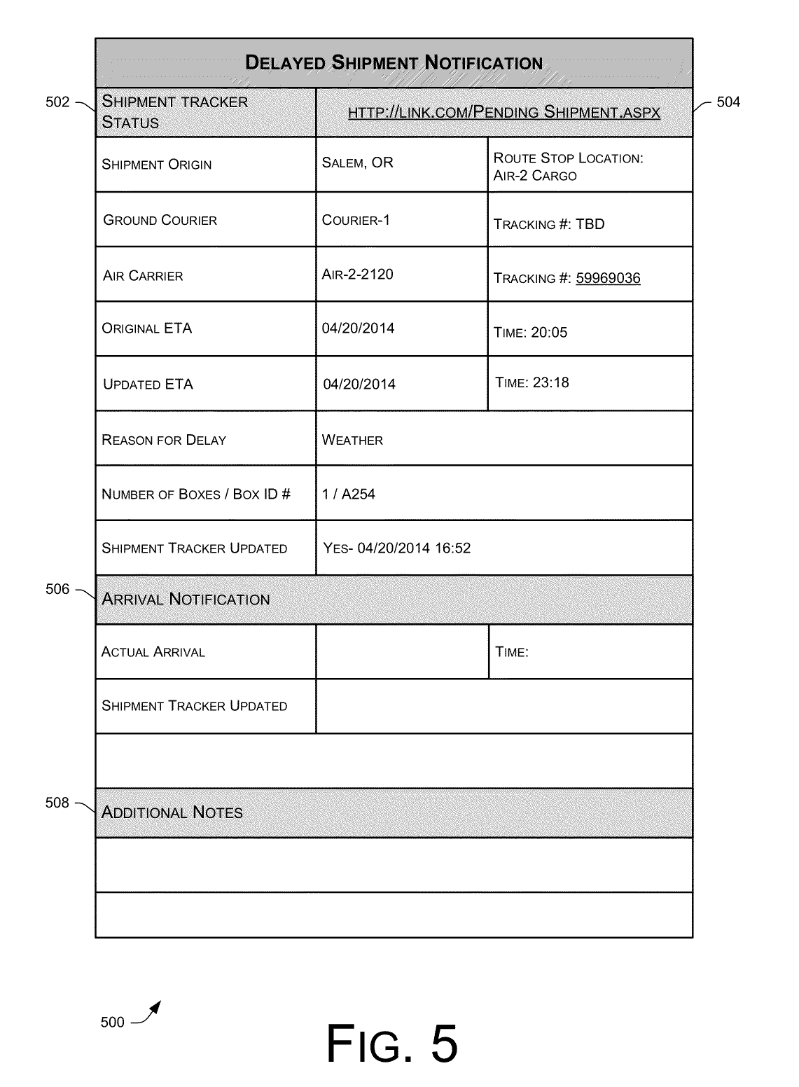

FIG. 5 illustrates an example notification 500 which may be generated, transmitted, and/or presented by the notification module 230 of the pending shipment module 222. As mentioned above, the notification module 230 may generate, transmit, and/or present the notification 500 to a user that a particular shipment has been delayed or canceled. In some implementations, the notification module 230 may include details in the generated notification corresponding to the delayed or canceled shipment. In some instances, the notification module 230 may generate a notification interface to be sent, for example, via email, short message service (SMS) or multimedia message service (MMS) to the user device 114 of the user 110 that a particular shipment has been delayed.

As illustrated in FIG. 5, the example notification 500 may include details regarding the current tracking information or shipment tracker status 502 acquired by the tracking service 102. For instance, FIG. 5 shows the example notification 500 including a shipment origin, a current route stop location, a ground courier with shipment tracking identification, an air courier with shipment air waybill identification, an original ETA, an updated ETA, a reason for delay, identification of the number of shipment items and tracking number for the items, and/or a most recent timestamp of a tracking service 102 update.

In some implementations, the notification 500 may include a link 504 to a tracking interface, such as the tracking interface 300, containing additional and/or up-to-date information regarding the delayed shipment.

In some implementations, the notification 500 may include or be updated with arrival notification 506 when the delayed shipment arrived to the user. In some implementations, when the tracking system receives an indication that the delayed shipment has arrived at the destination, the notification module 230 may generate, transmit, and/or present a new notification including the arrival notification 506 information. As shown in FIG. 5, the arrival notification 506 may include a date and time of actual arrival. In some implementations, the arrival notification 506 may include a most recent timestamp of a tracking service 102 update. That is, the last point in time that data from the one or more data sources 116 was acquired by the data acquisition module 210.

FIG. 5 also illustrates that the notification 500 may include an area for additional notes 508. In some implementations, the additional notes 508 may include any additional information that a user may like to add. In some implementations, user 110 may input additional that may support or inform the other users 112(1)-(N) of information pertaining to the delayed shipment. For instance, care instruction or information regarding the items in the delayed shipment.

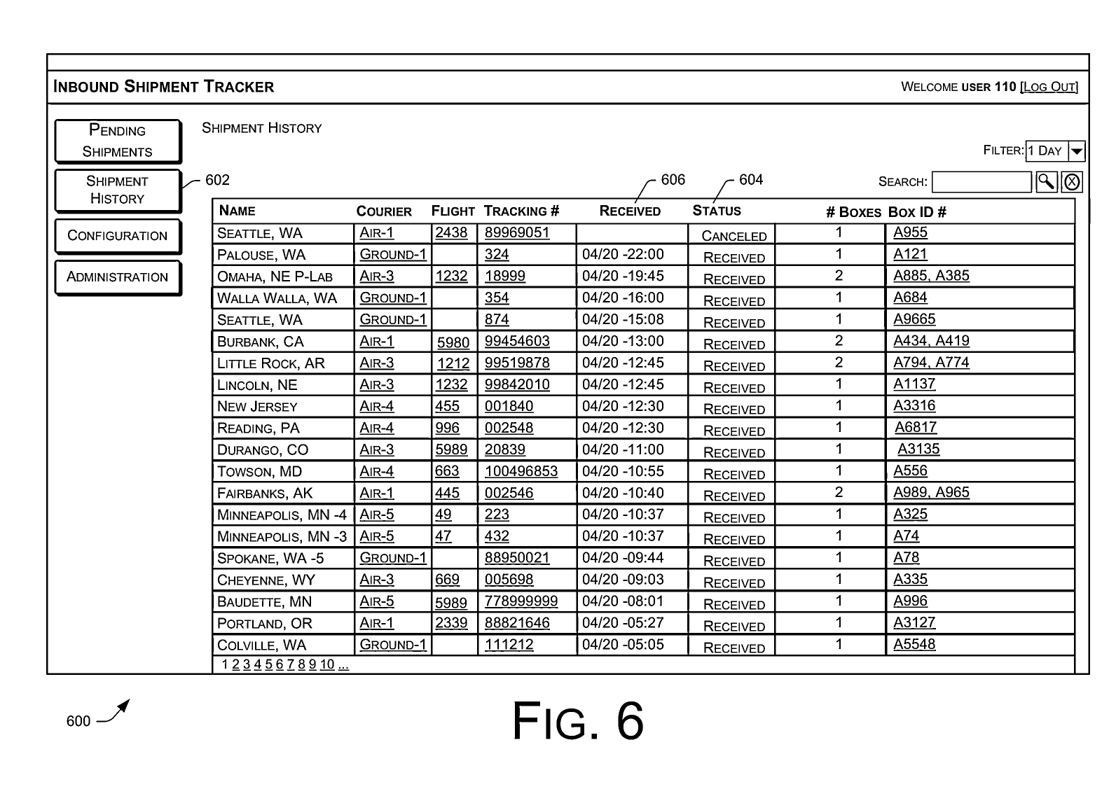

FIG. 6 illustrates an example tracking interface 600 generated by the shipment history module 224 of the interface module 214 for presentation on an electronic device. Tracking interface 600 shows that upon selection of the shipment history box 602 by user 110, the interface module 214 may provide an indication of the selection by, for example, highlighting shipment history box 602. The tracking interface 600 may include a log of one or more shipments received by the user. In some implementations, the tracking interface 600 may include a log of the shipments canceled prior to receipt by the user. The tracking interface 600 (and any other interface described herein) may include the same user functionality (i.e., sorting, filtering, hyperlinks, etc) as described above with reference to FIG. 3 and FIG. 4.

As illustrated in FIG. 6, the tracking interface 600 may display the status of one or more shipments at 604. In some implementations, the tracking interface 600 may indicate that the status of one or more shipments is currently canceled or received. As shown at 606 of FIG. 6, where the status of the one or more shipments is received, the tracking interface 600 also indicates the date/time that each shipment was received by user 110. In some implementations, upon receiving a request (i.e., click, touch, and so forth) from a user, the tracking interface 600 may display a pop-up window or redirect to an external location to present additional content (i.e., other user comments, vendor or courier comments, etc) to the user.

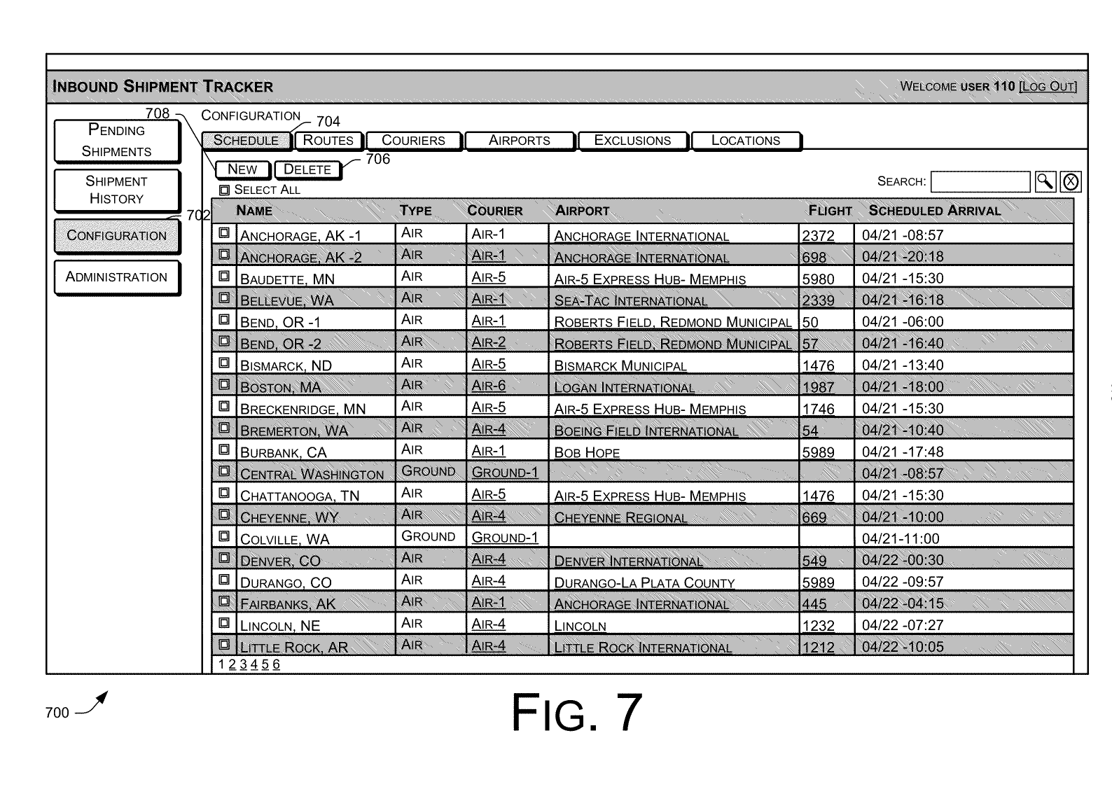

FIG. 7 illustrates an example tracking interface 700 generated by the configuration module 226 of the interface module 214 for presentation on an electronic device. Tracking interface 700 shows that upon selection of the configuration box 702 by user 110, the interface module 214 may provide an indication of the selection by, for example, highlighting configuration box 602.

In some implementations, one or more configuration options may appear within tracking interface 700 after receiving the selection of configuration box 702. The one or more configuration options may include options to configure (e.g., add new or delete existing) entire scheduled shipments, scheduled route stops within a shipment, couriers, airports, shipment exclusions, and/or shipment locations.

As shown in FIG. 7, upon selection of the schedule box 704, the tracking interface 700 may display columns and row of tracking information for all scheduled shipments to be received by user 110. As described above, user 110 may sort, filter or access a hyperlink associated with the columns and row of tracking information in tracking interface 700.

In some implementations, user 110 may select a particular scheduled shipment and by selecting a delete box 706, may delete the next scheduled arrival of the particular scheduled shipment. In some implementations, user 110 may select a new box 708 to allow for configuration of a new scheduled shipment. In these implementations, the configuration module 226 may provide the indication of a deleted and/or new scheduled shipment to the communication module 212. As described above, the communications module 212 may initiate communication with one or more courier, one or more shipment origination locations, one or more data sources 116 and/or the other users 112(1)-(N) to delete or edit an existing scheduled shipment or create a new schedule shipment.

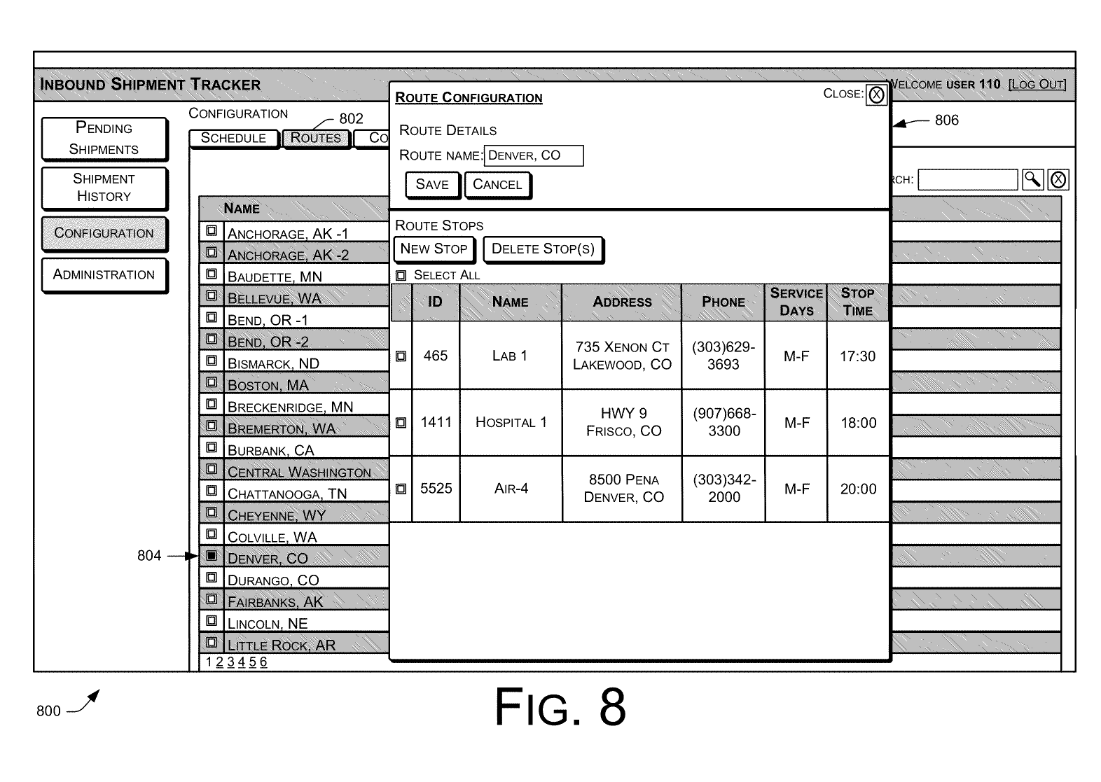

FIG. 8 illustrates another example tracking interface 800 generated by the configuration module 226 for presentation to a user on an electronic device. As shown in FIG. 8, upon selection of the route box 802 and specific route 804, the tracking interface 800 may display a pop-up box 806 which displays information corresponding to configuration of the selected specific route. For instance, pop-up box 806 show a route details such as the identification of stop along the route.

In some implementations, the pop-up box 806 presented by the configuration module may allow user 110 to add a new route stop and/or deleted existing route stops to an existing route. For instance, user 110 may select one or more of the route stops presented in the pop-up box 806 in order to delete the selected stops. In some instances, user 110 may utilize the information presented in the pop-up box 806 to add a route stop to a selected route. As described above, a route stop may be any type of location having items to ship to a user. For instance, where the user is a laboratory for testing samples, the route stops may be clinics, other labs, hospitals, blood banks, doctors offices, patient residences or any other location that may provide samples for testing.

In these implementations, the configuration module 226 may provide the indication of a new route stop and/or deleted route stop to the communication module 212. As described above, the communications module 212 may initiate communication with one or more couriers, one or more shipment origination locations, one or more data sources 116 and/or the other users 112(1)-(N) to add the new route stop and/or delete a route stop.

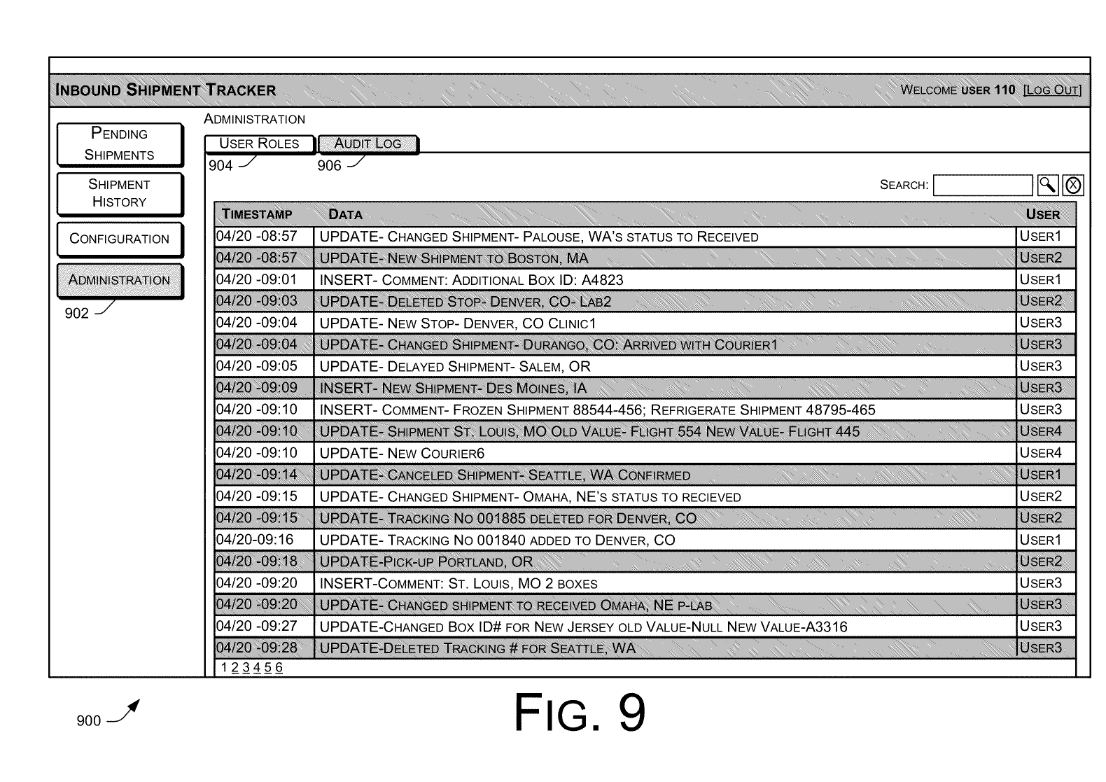

FIG. 9 illustrates an example tracking interface 900 generated by the administration module 228 of the interface module 214 for presentation on an electronic device. Tracking interface 900 shows that upon selection of the administration box 902 by user 110, the interface module 214 may provide an indication of the selection by, for example, highlighting administration box 902.

In some implementation, where the selecting user has been granted access to the administration tools, one or more administration tools may appear within tracking interface 900 after receiving the selection of administration box 902. In some implementations, the administration tools may include a user role tool 904 and an audit log 906.

Upon selection of the user role tool 904, the interface module 214 may provide an indication of the selection by, for example, highlighting the user role tool 904. In some implementations, the user role tool 904 may allow user 110 to add, delete, or otherwise alter the other users 112(1)-(N) access to selected areas of the tracking service 102. For instance, user 112 may restrict particular users from receiving the delayed shipment notification described above with regard to FIG. 5.

FIG. 9 also illustrates the audit log 906. In some implementations, upon selection of the audit log tool 906, the interface module 214 may provide an indication of the selection by, for example, highlighting the audit log tool 904. In some implementations, the audit log tool 904 may allow user 110 to view all actions taken by all other user 112(1)-(N) of the tracking service 102. For instance, as shown in FIG. 9, the audit log tool 906 of interface 900 may display a description of the action data undertaken by other user 112(1)-(N), a timestamp that the action took place, and/or the specific user who undertook the action.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed is:

1. A tracking system comprising:
one or more processors;
memory;
a data acquisition module stored in the memory and executable by the one or more processors to acquire data from one or more data sources, wherein the data acquired corresponds to tracking data of one or more items in transit from one or more locations;
a communications module stored in the memory and executable by the one or more processors to communicate with the one or more data sources to alter the transit of at least one of the one or more items from the one or more locations; and
an interface module stored in the memory and executable by the one or more processors to generate one or more interfaces for presentation on an electronic device, the one or more interfaces to present the data acquired by the data acquisition module, and the one or more interfaces comprising at least a pending shipment interface to display tracking data for the one or more items in transit from the one or more locations.

2. The system as recited in claim 1, wherein the one or more interfaces generated by the interface module for presentation on an electronic device further comprise:
a shipment history interface to display tracking data for one or more items previously received from the one or more locations;
a configuration interface in communication with the communications module including one or more controls usable to alter the transit of at least one of the one or more items from the one or more locations; and
an administration interface to display details about the data acquired from the one or more data sources by the data acquisition module and the communications with the one or more data sources by the communications module.

3. The system as recited in claim 1, wherein the tracking data comprises one or more of the following:
a status of each of the one or more items in transit from the one or more locations;
a name of the one or more locations;
a courier of each of the one or more items;
a tracking identification number of each of the one or more items in transit from the one or more locations;
an original estimated time of arrival of each of the one or more items in transit from the one or more locations;
an adjusted estimated time of arrival of each of the one or more items in transit from the one or more locations;
traffic information for a route of each of the one or more items in transit from the one or more locations;
weather information for the route of each of the one or more items in transit from the one or more locations;
a number of the one or more items in transit from the one or more locations; or
a tracking identification of each of the number of the one or more items in transit from the one or more locations.

4. The system as recited in claim 1, wherein the tracking data is acquired from one or more users of the tracking system.

5. The system as recited in claim 1, wherein the interface module generates one or more notifications for presentation on the electronic device, the one or more notifications comprising tracking data corresponding to a delay in transit for one of the one or more items from the one or more locations.

6. The system as recited in claim 5, wherein the one or more notifications generated by the interface module are sent to one or more users of the tracking system by at least one of an email, a short message service (SMS) or a multimedia message service (MMS).

7. One or more non-transitory computer-readable media storing computer-executable instructions that, when executed by one or more processors, cause the one or more processors to performs acts comprising:
accessing data associated with tracking data of one or more shipments in transit to a destination, the one or more shipments being from multiple locations; and
generating, based at least on the tracking data, one or more user interfaces for presentation on an electronic device, wherein at least one of the one or more user interfaces comprises tracking data corresponding to an adjusted estimated time of arrival of each of the one or more shipments in transit to the destination.

8. The one or more non-transitory computer-readable media as recited in claim 7, wherein the acts further comprise:
receiving a request to alter the one or more shipments by deleting one or more stops for one of the multiple locations; or
receiving a request to alter the one or more shipments by adding one or more stops for one of the multiple locations.

9. The one or more non-transitory computer-readable media as recited in claim 7, wherein the acts further comprise:
generating a notification for presentation on the electronic device, the notification comprising tracking data corresponding to a delay in transit for one of the one or more shipments; and
sending the notification to one or more users via an email, a short message service (SMS) or a multimedia message service (MMS).

10. The one or more non-transitory computer-readable media as recited in claim 7, wherein one or more user interfaces are configured to present a pop-up box to present additional details for the tracking data presented in each of the one or more interfaces.

11. The one or more non-transitory computer-readable media as recited in claim 7, wherein one or more user interfaces comprise one or more sort controls usable to sort the tracking data.

12. The one or more non-transitory computer-readable media as recited in claim 7, wherein the tracking data comprises one or more of the following:
a status of each of the one or more shipments;
a name of a location of the multiple locations;
a courier of each of the one or more shipments;
a tracking identification number of each of the one or more shipments;
an original estimated time of arrival of each of the one or more shipments;
traffic information for a route of each of the one or more shipments;
weather information for the route of each of the one or more shipments;
a number of items in each of the one or more shipments; or
a tracking identification of each of the number items in each of the one or more shipments.

13. The one or more non-transitory computer-readable media as recited in claim 7, wherein accessing the data associated with tracking data comprises acquiring the tracking data from one or more data sources, each of the one or more data sources maintained by one or more third party monitoring services, one or more weather monitoring systems, one or more traffic monitoring systems, one or more global positioning system monitoring systems, or one or more flight tracking networks.

14. The one or more non-transitory computer-readable media as recited in claim 7, wherein accessing the data associated with tracking data comprises acquiring the tracking data from one or more users.

15. A method comprising:
presenting, by one or more computing devices, one or more shipment tracking interfaces, wherein at least one of the one or more shipment tracking interfaces comprises route details corresponding to one or more stops in transit toward a destination of one or more shipments;
receiving, by at least one computing device of the one or more computing devices, a request to alter the route details of one of the one or more shipments; and
communicating, by at least one computing device of the one or more computing devices, the request to the one or more stops to alter the route details.

16. The method as recited in claim 15, further comprising altering, by at least one computing device of the one or more computing devices, the route details for the one of the one or more shipments by one or more of the following:
deleting one or more stops for the route; or
adding one or more stops for the route.

17. The method as recited in claim 15, wherein the communicating further comprises the request to one or more couriers to alter the route details.

18. The method as recited in claim 15, further comprising:
acquiring tracking data associated with the one or more shipments in transit toward the destination from one or more data sources, each of the one or more data sources maintained by one or more third party monitoring services, one or more weather monitoring systems, one or more traffic monitoring systems, one or more global positioning system monitoring systems, or one or more flight tracking networks; and
generating, based at least on the acquired tracking data, an adjusted estimated time of arrival of each of the one or more shipments in transit toward the destination for presentation in at least one of the one or more shipment tracking interfaces.

19. The method as recited in claim 18, wherein the tracking data comprises one or more of the following:
a status of each of the one or more shipments;
a courier of each of the one or more shipments;
a tracking identification number of each of the one or more shipments;
an original estimated time of arrival of each of the one or more shipments;
traffic information for a route of each of the one or more shipments;
weather information for the route of each of the one or more shipments;
a number of items in each of the one or more shipments; or
a tracking identification of each of the number items in each of the one or more shipments.

20. The method as recited in claim 15, wherein the presented one or more shipment tracking interfaces may be presented simultaneously on a plurality of electronic devices.
